(19) United States
(12) Patent Application Publication
(10) Pub. No.: US 2025/0381431 A1
(43) Pub. Date: Dec. 18, 2025

(54) ALL-SOLID-STATE RECHARGEABLE BATTERY STRUCTURE

(71) Applicant: SAMSUNG SDI CO., LTD., Yongin-si, Gyeonggi-do (KR)

(72) Inventors: Ik Hwan CHO, Yongin-si, Gyeonggi-do (KR); Byeongdo KWAK, Yongin-si, Gyeonggi-do (KR); Changhee WOO, Yongin-si, Gyeonggi-do (KR); Isaac SHIN, Yongin-si, Gyeonggi-do (KR); Riyul KIM, Yongin-si, Gyeonggi-do (KR); Jinhwan PARK, Yongin-si, Gyeonggi-do (KR)

(73) Assignee: SAMSUNG SDI CO., LTD., Yongin-si, Gyeonggi-do (KR)

(21) Appl. No.: 18/879,870

(22) PCT Filed: Jan. 4, 2024
(86) PCT No.: PCT/KR2024/000230

§ 371 Date: Dec. 30, 2024

(30) Foreign Application Priority Data
Mar. 10, 2023 (KR) 10-2023-0032012

(51) Int. Cl. A62C 35/10; A62C 3/16; H01M 10/0585; H01M 10/613; H01M 10/6555

(52) U.S. Cl. CPC A62C 35/10; A62C 3/16; H01M 10/0585; H01M 10/613; H01M 10/6555; H01M 2200/10

(57) ABSTRACT

The present invention relates to an all-solid-state rechargeable battery structure, including two or more unit cells including a positive electrode, a negative electrode, and a solid electrolyte layer between the positive electrode and the negative electrode, and elastic sheets located between and at the outermost end of the unit cells, wherein at least one of the elastic sheets includes an extinguishing capsule.

### TECHNICAL FIELD

All-solid-state rechargeable battery structures are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Commercially available rechargeable lithium batteries use an electrolyte solution including a flammable organic solvent and thus have safety issues such as explosion or ignition, when crashed, penetrated, or etc. Accordingly, semi-solid batteries or all-solid-state batteries which use no electrolyte solution have been proposed. All-solid-state batteries among rechargeable lithium batteries refer to batteries made of all solid materials and particularly, using a solid electrolyte. Such all-solid-state batteries are safe due to no explosion risk according to leakage of the electrolyte solution and the like and thus may be easily manufactured into a thin battery.

### DISCLOSURE

By applying an elastic sheet that can sufficiently relieve stress transmitted during the pressurizing process in the manufacture of an all-solid-state rechargeable battery and stress generated by changes in the thickness of the battery during repeated charging and discharging, while at the same time ensuring fire safety, the cycle-life characteristics and safety of an all-solid-state rechargeable battery are improved.

In an embodiment, an all-solid-state rechargeable battery structure includes two or more unit cells including a positive electrode, a negative electrode, and a solid electrolyte layer between the positive electrode and the negative electrode, and elastic sheets between the unit cells and at the outermost end of the unit cells, wherein at least one of the elastic sheets include an extinguishing capsule.

According to an embodiment of the present invention, an all-solid-state rechargeable battery structure effectively alleviates stress during the battery manufacturing process and charging/discharging according to the design of an elastic sheet, thereby improving cycle-life characteristics and ensuring fire safety.

### DESCRIPTION OF THE DRAWINGS

FIGS. 1 to 3 are cross-sectional views schematically showing all-solid-state rechargeable battery structures according to embodiments.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### All-Solid-State Rechargeable Battery Structure

In an embodiment, an all-solid-state rechargeable battery structure includes two or more unit cells including a positive electrode, a negative electrode, and a solid electrolyte layer between the positive electrode and the negative electrode, and elastic sheets between the unit cells and at the outermost end of the unit cells, wherein at least one of the elastic sheets includes an extinguishing capsule.

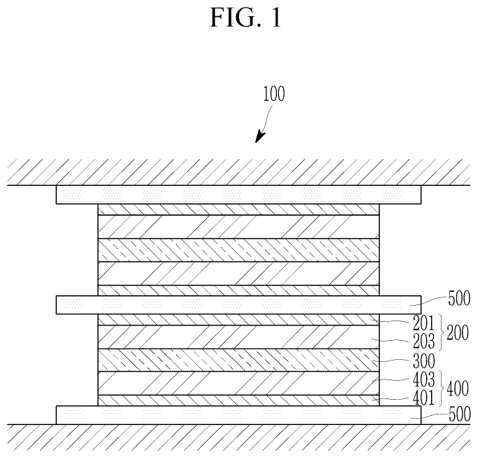

FIG. 1 is a cross-sectional view of an all-solid-state rechargeable battery according to an embodiment. Referring to FIG. 1, the all-solid-state rechargeable battery 100 has a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100 may further include at least one elastic layer 500 on the outside of at least either one of the positive electrode 200 and the negative electrode 400. FIG. 1 illustrates an assembly in which two unit cells including a negative electrode 400, a solid electrolyte layer 300, and a positive electrode 200 are stacked, but three or more, for example, 2 to 100, 3 to 50, 4 to 20, etc. may be stacked.

In all-solid-state secondary batteries 100, a sulfide-based solid electrolyte with high ionic conductivity is generally used. However, the sulfide-based solid electrolyte has a property of deteriorating in air, so that it is necessary to block it from the atmosphere. Therefore, an electrode assembly including the sulfide-based solid electrolyte is inserted into a case using a laminate film or a rigid material and then, sealed and pressed, manufacturing the battery. However, stress during the pressing may be transmitted to the solid electrolyte and thus break it, or as a thickness of an electrode changes according to charges and discharges, the stress is accumulated and causes a crack in the solid electrolyte, resulting in a short circuit. In addition, when not uniformly pressed from the outside during the battery discharge, lithium ions may move at a lower speed or toward a locally pressed region, deteriorating discharge efficiency. Furthermore, the non-uniform pressing may break the solid electrolyte.

Accordingly, a technique of applying an elastic sheet 500 to the outside of the electrode assembly has been developed. Here, the elastic sheet 500 may be a buffer layer or an elastic layer, and serves to ensure that pressure is uniformly transmitted to the electrode assembly to ensure good contact between solid components, and also to relieve stress transmitted to the solid electrolyte, etc., and can serve to suppress cracks from occurring in the solid electrolyte due to stress accumulation according to changes in the thickness of the electrode during charging and discharging.

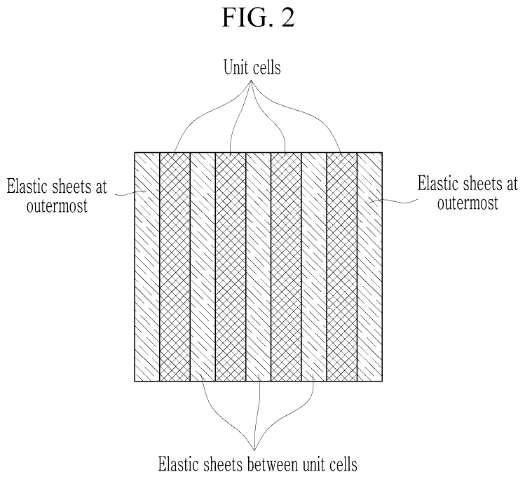

Referring to FIG. 2, the elastic sheet 500 is disposed between the unit cells and also at the outermost end of the unit cells. During charging and discharging, the thickness of the negative electrode in particular changes significantly due to lithium deposition or dendrite formation, and the thickness of the positive electrode also changes due to lithium intercalation and deintercalation. Because the elastic sheet 500 is located between the unit cells and at the outermost layer, it can play a role in buffering problems due to thickness changes. In addition, since the elastic sheet 500 is located on the outside of the positive and negative electrodes, there is no phenomenon of deterioration due to reaction with lithium, and thus, the effect of increasing the coulombic efficiency of the battery can be obtained.

However, because existing silicone-based elastic sheets, rubber-based elastic sheets, urethane-based elastic sheets, and acrylic-based elastic sheets are flammable materials, there is a risk that flammable gases may be generated at high temperatures when the battery is not functioning properly, leading to a fire.

### Elastic Sheet

An all-solid-state rechargeable battery structure according to one embodiment is characterized in that at least one of the elastic sheets includes an extinguishing capsule.

The extinguishing capsule refers to a capsule having a extinguishing function. The extinguishing capsule includes an extinguishing agent. The extinguishing capsule is structured so that when the battery is overheated above a certain temperature, the surface of the capsule melts or bursts, releasing the extinguishing agent inside. The released extinguishing agent can suppress combustion or explosion of the battery by performing heat absorption and/or oxygen blocking functions. By including at least one of the elastic sheets with the extinguishing capsule, it can be much more effective in suppressing explosion of the battery in case of issues such as overheating or collision of the battery.

Because the extinguishing capsule is included in the elastic sheet within the all-solid-state battery, it may have a size smaller than the thickness of the elastic sheet. Because the thickness of the elastic sheet is generally on the order of 100 μm to 1 mm, the average particle diameter of the extinguishing capsule used here may be about 100 nm to 50 μm, for example 500 nm to 50 μm, 1 μm to 50 μm, or 10 μm to 40 μm. When the extinguishing capsule satisfies the particle size range, it can be evenly distributed within the elastic sheet and can prevent ignition, combustion, explosion, etc. of the battery when an issue occurs in the battery without impairing the performance of the battery, such as the charge/discharge function and cycle characteristics during normal times. For example, applying an extinguishing capsule having a particle size of 100 μm or more to a battery is not desirable because it may impair the performance of the battery under normal conditions. Here, the average particle size of the extinguishing capsule may be determined by randomly measuring the particle sizes (diameter or length of the major axis) of about 20 extinguishing capsules from scanning electron microscopy images of the elastic sheet or the extinguishing capsules, calculating an arithmetic average of these, and taking this as the average particle size.

The extinguishing capsule may be included in an amount of 1 wt % to 40 wt %, for example, 10 wt % to 35 wt %, 15 wt % to 30 wt %, etc. based on 100 wt % of one elastic sheet

Additionally, the extinguishing capsule may be included in an amount of 1 volume % to 40 volume %, for example 10 volume % to 35 volume %, or 15 volume % to 30 volume % based on 100% by volume of one elastic sheet. When the above extinguishing capsule is included in the above range, it is possible to effectively prevent explosion of the battery when issues such as overheating or collision occur without impeding the performance of the battery under normal conditions.

The extinguishing capsule may have, for example, a core-shell structure. In this case, the core may include an extinguishing agent, and the shell may include a polymer that melts at 80° C. to 160° C.

The polymer that melts at 80° C. to 160° C. included in the shell may be, for example, a polymer melting at 80° C. to 120° C., or 80° C. to 100° C., and may be, for example, a polymer including at least one of polystyrene, polyurethane, polyurea, polyepoxide, polynitrile, polyacrylate, polyamide, polyolefin, a copolymer thereof, and a mixture thereof. The shell including these polymers may melt, burst, or deform when the temperature of the battery rises, thereby releasing the extinguishing agent inside.

The extinguishing agent included in the core can play a role in preventing ignition, combustion, explosion, etc. of the battery by directly performing heat absorption function and/or oxygen blocking function, and is distinguished from a flame retardant compound, a non-combustible compound, a foaming compound, etc. The extinguishing agent may be used without limitation as long as it is a material having an extinguishing function, and as an example, the extinguishing agent may include, but is not limited to, iodotrifluoromethane, 1-iodoheptafluoropropane, 2-iodoheptafluoropropane, iodopentafluoroethane, 2,2-diiodo-1,1,1,3,3,3-hexafluoropropane, 1,2-dibromoethane, dibromomethane, or a combination thereof.

The thickness of the elastic sheet may be 100 μm to 800 μm. For example, the elastic sheet may have a different thickness depending on the location, for example, the thickness of the elastic sheet located between the unit cells may be 100 μm to 300 μm, and the thickness of the elastic sheet located at the outermost end of the unit cell may be 150 μm to 800 μm. For example, the elastic sheet located at the outermost end may be thicker than the elastic sheet located between the unit cells.

The elastic sheet basically includes a polymer resin. Here, the type of polymer resin is not particularly limited, but may include, for example, polyacrylate, polyurethane, silicone, fluorinated polymer, copolymers thereof, or a combination thereof.

The polyacrylate means a homopolymer or copolymer having an acrylic group, and the above polyurethane means a homopolymer or copolymer having a urethane group. The silicone may also be called a silicone resin and means a homopolymer or copolymer including silicon, and the fluorine-based polymer means a homopolymer or copolymer including fluorine. These polymers can exhibit appropriate elasticity, modulus, and compressive strain, making them suitable for use as elastic sheets.

The above polyacrylate may be derived from, for example, a C1 to C20 alkyl acrylate, a hydroxy C1 to C20 alkyl acrylate, or a combination thereof.

Here, C1 to C20 represent the number of carbon atoms in the alkyl group, and may be, for example, C1 to C18, C1 to C15, C1 to C12, C1 to C10, C1 to C8, or C1 to C5. Here, acrylate is a concept that includes acrylate and methacrylate. The C1 to C20 alkyl acrylate may be, for example, methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, 2-propyloctyl (meth)acrylate, or a combination thereof.

The hydroxy C1 to C20 alkyl acrylate may be, for example, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

For example, the acrylate resin may be derived from a C1 to C20 alkyl acrylate and a hydroxy C1 to C20 alkyl acrylate, and at this time, a mixing ratio of the C1 to C20 alkyl acrylate and the hydroxy C1 to C20 alkyl acrylate may be a weight ratio of 20:80 to 90:10, for example, a weight ratio of 30:70 to 90:10, 40:60 to 90:10, 50:50 to 90:10, 60:40 to 80:20. In this case, the acrylate resin can exhibit appropriate adhesiveness and is advantageous in implementing excellent compressive strength, stress relaxation rate, and recovery rate.

The acrylate resin may further include other repeating units derived from acrylic acid, an alkoxy group-containing acrylate, etc. Additionally, the weight average molecular weight of the acrylate resin may be from 400,000 to 2,000,000, but is not limited thereto.

The elastic sheet may further include elastic particles in addition to the polymer resin. The elastic particles may be particles made of a polymer having elasticity, such as rubber. The elastic particles may increase the restoring force while maintaining the stress relaxation ability of the polymer resin.

The elastic particles may be included in an amount of 0.1 parts by weight to 5 parts by weight, for example 0.5 parts by weight to 4 parts by weight, 1 part by weight to 3 parts by weight, based on 100 parts by weight of the polymer resin. When the elastic particles are included in this content range, the compressive strength, stress relaxation strength, and restoring force may be maximized without lowering the density and adhesiveness of the polymer resin.

The elastic particles may include polymers derived from, for example, natural rubber, alkyl acrylates, olefins, butadiene, isoprene, styrene, acrylonitrile, copolymers thereof, or a combination thereof. The elastic particles may have a glass transition temperature of, for example, −70° C. to 0° C.

The alkyl acrylate may be a C1 to C20 alkyl acrylate, and can be, for example, methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, and 2-propyloctyl (meth)acrylate, or a combination thereof.

The elastic particles may include, for example, polyalkyl acrylate, an ethylene-propylene-diene rubber, a butadiene rubber, an isoprene rubber, styrene-butadiene rubber, a styrene-isoprene rubber, an acrylonitrile-butadiene rubber, or a combination thereof.

The elastic particles may have, for example, a core-shell structure, in which case it is advantageous to exhibit appropriate size and elasticity. The core and shell may each include, for example, a polyalkyl acrylate, for example, the core may comprise polybutyl (meth)acrylate and the shell may include polymethyl (meth)acrylate. In this case, the dispersibility may be improved and the compressive strength, stress relaxation ability and restoring force of the elastic sheet may be improved.

The elastic particles may be, for example, nano-sized. Specifically, the size (D50) of the elastic particles may be 10 nm to 900 nm, for example 10 nm to 700 nm, 50 nm to 500 nm, or 100 nm to 400 nm. The elastic particles satisfying these sizes have excellent dispersibility within the elastic sheet composition and can increase the restoring force while maintaining the stress relaxation ability of the elastic sheet. Here, the size of the elastic particles may be expressed as an average particle diameter or median particle diameter, and may mean a diameter of the particles (D50) whose cumulative volume is 50 volume % in the particle size distribution as measured by a particle size analyzer.

The elastic sheet may further include inorganic particles. In this case, the modulus and compressive strength of the elastic sheet can be improved while simultaneously improving the recovery rate.

The inorganic particles may include, for example, alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

The inorganic particles may be included, for example, in an amount of 0.001 to 50 parts by weight, for example, 0.01 to 45 parts by weight, or 0.1 to 40 parts by weight, based on 100 parts by weight of the polymer resin. In this case, the compressive strength, stress relaxation rate, and recovery rate of the elastic sheet may be improved without deteriorating the properties of the polymer resin.

The average particle size of the aforementioned inorganic particles may be 0.1 μm to 5 μm, for example 0.1 μm to 2.5 μm, or 0.2 μm to 2 μm. The average particle size may be measured using a laser scattering particle size distribution meter, and may refer to the median particle size (D50) when 50% of the small particles are accumulated in volume conversion.

The elastic sheet may further include suitable additives in addition to the aforementioned components, for example, an initiator, a crosslinking agent, a coupling agent, a stabilizing agent, etc. Each additive may be included in an appropriate amount according to the intended purpose, and may be included, for example, in an amount of 0.001 parts by weight to 1 parts by weight, for example 0.01 parts by weight to 0.8 parts by weight based on 100 parts by weight of the polymer resin.

In the all-solid-state rechargeable battery structure, the extinguishing capsule may be included in all of the elastic sheets or may be included in only some of the elastic sheets. For example, the all-solid-state rechargeable battery structure may include both an elastic sheet including an extinguishing capsule and an elastic sheet not including an extinguishing capsule.

For example, the elastic sheet located between the unit cells may not include the extinguishing capsule, and only the elastic sheet located at the outermost end of the unit cells may include the extinguishing capsule. At this time, the elastic sheet between the unit cells may have relatively hard properties and may be in the form of a foam, and the elastic sheet at the outermost end of the unit cells and including the extinguishing capsule may be relatively soft, have a low modulus, and may be in the form of a pad. It is advantageous to design the elastic sheet in this way to strengthen its impact-absorbing role while simultaneously ensuring fire safety.

For example, the density of the elastic sheet located between the unit cells may be 0.3 g/cm³ to 1.0 g/cm³, and the density of the elastic sheet located at the outermost end of the unit cells and including the extinguishing capsule may be 0.7 g/cm³ to 6 g/cm³. For example, the density of elastic sheets located at the outermost end of the unit cells may be higher than the density of elastic sheets located between the unit cells. For example, the elastic sheet without the extinguishing capsule may be porous, and the elastic sheet with the extinguishing capsule may, in contrast, have relatively high density by having extinguishing capsule without pores.

In addition, the modulus (25° C., 1 Hz) of the elastic sheet located between the unit cells may be 1×10⁵ Pa to 6×10⁶ Pa, and the modulus of the elastic sheet located at the outermost end of the unit cells and including the extinguishing capsule may be ×10⁵ Pa to 6×10⁶ Pa. For example, the modulus of the elastic sheet located at the outermost end of the unit cells may be higher than the modulus of the elastic sheet located between the unit cells. When the modulus of each elastic sheet satisfies the above range, or when the properties of the elastic sheet are designed to be appropriately different depending on the location, the impact absorbing function can be strengthened while also ensuring fire safety.

Additionally, the elastic sheet may have different thicknesses depending on the location. For example, the thickness of the elastic sheet located between the unit cells may be 100 μm to 300 μm, and the thickness of the elastic sheet located at the outermost end of the unit cells and including the extinguishing capsule may be 150 μm to 800 μm. For example, the thickness of the elastic sheet located at the outermost end of the unit cells may be greater than the thickness of the elastic sheet located between the unit cells.

The permanent strain of the elastic sheet located between the unit cells may be 30% to 70%, and the permanent strain of the elastic sheet located at the outermost end of the unit cells and including the extinguishing capsule may be 30% to 70%. For example, the permanent strain of the elastic sheet located between unit cells may be lower than or equal to the permanent strain of the elastic sheet located at the outermost end of the unit cells. That is, the elastic sheet located between the unit cells may have a relatively low permanent strain and thus better resilience. It may be desirable for the elastic sheet, which is located at the outermost end and includes the extinguishing capsule, to have a relatively high permanent strain. In this case, the all-solid-state rechargeable battery structure can effectively alleviate volume changes and external impacts due to charging and discharging, thereby maximizing the safety and electrochemical performance of the battery.

In addition, the impact absorption rate (Ball Drop 7 g, 20 cm) of the elastic sheet located between the unit cells may be 40% to 60%, and the impact absorption rate of the elastic sheet located at the outermost end of the unit cells and including the extinguishing capsule may be 30% to 60%. For example, the impact absorption rate of an elastic sheet located between unit cells may be higher than the impact absorption rate of the elastic sheet located at the outermost end of the unit cells.

The compressive strength at CFD of 50% of the elastic sheet located between the unit cells may be 0.6 MPa to 2 MPa, and the compressive strength at CFD of 50% of the elastic sheet located at the outermost end of the unit cells and including the extinguishing capsule may be 0.8 MPa to 2 MPa. For example, the compressive strength of an elastic sheet located between unit cells may be lower than the compressive strength of an elastic sheet located at the outermost end of the unit cells.

Additionally, the stress relaxation rate of the elastic sheet including the extinguishing capsule may be lower than that of the elastic sheet not including the extinguishing capsule. Additionally, the recovery rate of the elastic sheet including the extinguishing capsule may be higher than that of the elastic sheet not including the extinguishing capsule. When designed in this way, the all-solid-state rechargeable battery structure can maximize its ability to alleviate volume changes and external shocks.

Here, the measurement methods and measurement conditions for permanent strain, impact absorption rate, CFD compressive strength, stress relaxation rate, and recovery rate are the same as those described in Evaluation Example 1.

### Solid Electrolyte Layer

In an all-solid-state rechargeable battery according to an embodiment, the solid electrolyte layer 300 may include an inorganic solid electrolyte such as a sulfide-based solid electrolyte or an oxide-based solid electrolyte.

For example, the solid electrolyte layer 300 may include a sulfide-based solid electrolyte having excellent ionic conductivity. The sulfide-based solid electrolyte particles may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂-LisPO₄, Li₂S—SiS₂-LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a mole ratio of 50:50 to 90:10 or 50:50 to 80:20 and optionally, performing heat treatment. Within the above mixing ratio range, a sulfide-based solid electrolyte having excellent ionic conductivity can be manufactured. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include argyrodite-type sulfide. The argyrodite-type sulfide may be represented by, for example, a chemical formula of LiaMbPcSaAe (wherein a, b, c, d, and e are all 0 or more and 12 or less, M is Ge, Sn, Si, or a combination thereof, and A is F, Cl, Br, or I), and as a specific example, may be represented by a chemical formula of Li₂₋ₓPS₆₋ₓAₓ (wherein x is 0.2 or more and 1.8 or less, and A is F, Cl, Br, or I). The argyrodite-type sulfide may specifically be Li₃PS₄, Li₂P₃S₁₁, Li₂PS₆, Li₃PS₅Cl, Li₃PS₅Br, Li_{5.8}PS_{4.8}Cl_{1.2}, Li_{6.2}PS_{5.2}Br_{0.8}, etc.

The sulfide-based solid electrolyte including such an argyrodite-type sulfide-based solid electrolyte may have high ionic conductivity close to the range of 10-4 to 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The solid electrolyte layer 300 may include an oxide-based inorganic solid electrolyte. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (LisPO₄), lithium titanium phosphate (LiₓTi_{y}(PO₄)₃, 0<x<2, 0<y<3), Li_{1+x+y} (Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LlAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a mixture thereof.

The solid electrolyte is in the form of particles and may have an average particle diameter (D50) of less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte may be small particles having a size of 0.1 μm to 1.9 μm, large particles having a size of 2.0 μm to 5.0 μm, or a mixture thereof. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

Meanwhile, the average particle diameter (D50) of the solid electrolyte included in the solid electrolyte layer 300 may be larger than the average particle diameter (D50) of the solid electrolyte included in the positive electrode 200. In this case, the energy density of the all-solid-state rechargeable battery may be maximized while increasing the mobility of lithium ions to improve the overall performance. For example, the average particle diameter (D50) of the solid electrolyte included in the positive electrode 200 may be 0.1 μm to 1.9 μm, or 0.1 μm to 1.0 μm, and the average particle diameter (D50) of the solid electrolyte included in the solid electrolyte layer 300 may be 2.0 μm to 5.0 μm, or 2.0 μm to 4.0 μm, or 2.5 μm to 3.5 μm. When this particle size range is satisfied, the energy density of the all-solid-state rechargeable battery may be maximized while the transfer of lithium ions is facilitated, thereby suppressing resistance and improving the overall performance of the all-solid-state rechargeable battery.

The solid electrolyte layer 300 may further include a binder in addition to the solid electrolyte. The binder may include, for example, a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, polyvinylidene fluoride-hexafluoropropylene copolymer, polyvinyl chloride, carboxylated polyvinyl chloride, polyvinyl fluoride, polyethylene, polypropylene, an ethylene propylene copolymer, an ethylene propylene diene copolymer, polyamideimide, polyimide, poly(meth)acrylate, polyacrylonitrile, polystyrene, polyurethane, or a combination thereof.

The solid electrolyte layer 300 may be formed by adding a solid electrolyte to a binder solution, coating it on a substrate film, and drying it. The solvent of the binder solution may be isobutyryl isobutyrate, xylene, toluene, benzene, hexane or a combination thereof. Because the above solid electrolyte layer formation process is widely known in the art, a detailed description will be omitted.

The solid electrolyte layer 300 may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LIB(C₂O₄)₂, LiBF₄, LiBF₃ (C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂) (CF₃SO₂)N—, and (CF₃SO₂)₂N—.

The ionic liquid may be, for example, one or more selected from N-methyl-N-propylpyrrolidinium bis(trifluoromethanesulfonyl)imide, N-butyl-N-methylpyrrolidinium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

In the solid electrolyte layer, a weight ratio of the solid electrolyte and the ionic liquid in the solid electrolyte membrane may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2).

In addition, a thickness of the carbon coating layer may be about 5 nm to 100 nm. As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

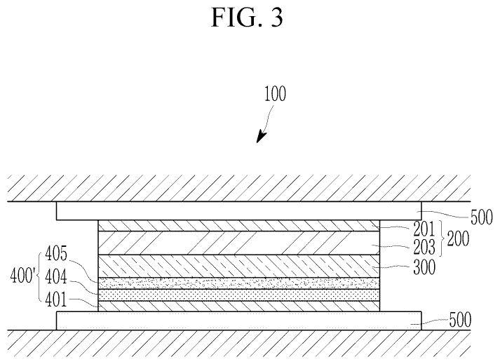

FIG. 3 is a schematic cross-sectional view of an all-solid-state rechargeable battery including a precipitation-type negative electrode. Referring to FIG. 3, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and may optionally include a binder and/or a conductive material.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

$$L {i}_{a} {A}_{1 - b} {X}_{b} {D}_{2} ( 0.90 \leq a \leq 18 , 0 \leq b \leq 0.5 ) ;$$

$$L {i}_{a} {A}_{1 - b} {X}_{b} {O}_{2 - c} {D}_{c} ( 0.90 \leq a \leq 1.8 , 0 \leq b \leq 0.5 , 0 \leq c \leq 0.05 ) ;$$

$$L {i}_{a} {E}_{1 - b} {X}_{b} {O}_{2 - c} {D}_{c} ( 0.90 \leq a \leq 1.8 , 0 \leq b \leq 0.5 , 0 \leq c \leq 0.05 ) ;$$

$$L {i}_{a} {E}_{2 - b} {X}_{b} {O}_{4 - c} {D}_{c} ( 0.9 \leq a \leq 1.8 , 0 \leq b \leq 0.5 , 0 \leq c \leq 0.05 ) ;$$

$$L {i}_{a} N {i}_{1 - b - c} C {o}_{b} {X}_{c} {D}_{α} ( 0.9 \leq a \leq 1.8 , 0 \leq b \leq 0.5 , 0 \leq c \leq 0.5 , 0 < α \leq 2 ) ;$$

$$L {i}_{a} N {i}_{1 - b - c} C {o}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$$L {i}_{a} N {i}_{1 - b - c} C {o}_{b} {X}_{c} {O}_{2 - α} {T}_{2} ( 0.90 \leq a \leq 1.8 , 0 \leq b \leq 0.5 , 0 \leq c \leq 0.05 , 0 < α < 2 ) ;$$

$${Li}_{a} N {i}_{1 - b - c} {Mn}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$$L {i}_{a} N {i}_{1 - b - c} M {n}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} N {i}_{1 - b - c} M {n}_{b} {X}_{c} {O}_{2 - α} {T}_{α} ( 0.9 \leq a \leq 1.8 , 0 \leq b \leq 0.5 , 0 \leq c \leq 0.05 , 0 < α < 2 ) ;$$

$${Li}_{a} N {i}_{1 - b - c} M {n}_{b} {X}_{c} {O}_{2 - α} {T}_{2} ( 0.9 \leq a \leq 1.8 , 0 \leq b \leq 0.5 , 0 \leq c \leq 0.05 , 0 < α < 2 ) ;$$

$$L {i}_{a} N {i}_{b} {E}_{c} {G}_{d} {O}_{2} ( 0.90 \leq a \leq 1.8 , 0 \leq b \leq 0 \text{.9} , 0 \leq c \leq 0 \text{.5} , 0.001 \leq d \leq 0.1 ) ;$$

$$L {i}_{a} N {i}_{b} C {o}_{c} M {n}_{d} {G}_{e} {O}_{2} ( 0.90 \leq a \leq 1.8 , 0 \leq b \leq 0 \text{.9} , 0 \leq c \leq 0 \text{.5} , 0 \leq d \leq 0.5 , 0.001 \leq e \leq 0 \text{.1} ) ;$$

$$L {i}_{a} {NiG}_{b} {O}_{2} ( 0.90 \leq a \leq 1.8 , 0.001 \leq b \leq 0 \text{.1} ) ;$$

$$L {i}_{a} {CoG}_{b} {O}_{2} ( 0.90 \leq a \leq 1.8 , 0.001 \leq b \leq 0 \text{.1} ) ;$$

$$L {i}_{a} M {n}_{1 - b} {G}_{b} {O}_{2} ( 0.9 \leq a \leq 1.8 , 0.001 \leq b \leq 0 \text{.1} ) ;$$

$$L {i}_{a} M {n}_{2} {G}_{b} {O}_{4} ( 0.9 \leq a \leq 1.8 , 0.001 \leq b \leq 0 \text{.1} ) ;$$

$$L {i}_{a} M {n}_{1 - g} {G}_{g} P {O}_{4} ( 0.9 \leq a \leq 1.8 , 0 \leq g \leq 0 \text{.5} ) ;$$

QO₂; QS₂; LiQS₂;
V₂O₅; LiV₂O₅;
LiZO₂;
LiNIVO₄;

$$\begin{matrix}L {i}_{( 3 - f )} {{J}_{2} ( P {O}_{4} )}_{3} ( 0 \leq f \leq 2 ) ; \\ {Li}_{( 3 - f )} F {{e}_{2} ( P {O}_{4} )}_{3} ( 0 \leq f \leq 2 ) ; \\ {Li}_{a} F e P {O}_{4} ( 0.90 \leq a \leq 1.8 ) .\end{matrix}$$

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

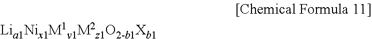

In Chemical Formula 11, 0.9≤a1≤1.8, 0.3≤x1≤1, 0≤yl≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤yl≤0.4, and 0≤z1≤0.4 or 0.8≤x1≤1, 0≤yl≤0.2, and 0≤z1≤0.2.

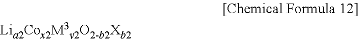

In Chemical Formula 12, 0.9≤a2≤1.8, 0.7≤x2 1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

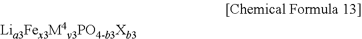

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

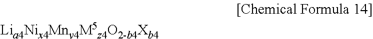

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Here, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Solid Electrolyte

The solid electrolyte included in the positive electrode active material layer may include a sulfide-based solid electrolyte, an oxide-based solid electrolyte, or a combination thereof, and may be, for example, an argyrodite-type sulfide-based solid electrolyte. Because the solid electrolyte has been described above, a detailed description is omitted.

Based on 100 wt % of the positive electrode active material layer, the solid electrolyte may be included in an amount of 0.1 wt % to 35 wt %, for example, 1 wt % to 35 wt %, 5 wt % to 30 wt %, 8 wt % to 25 wt %, or 10 wt % to 20 wt %.

Additionally, in the positive electrode active material layer, 65 wt % to 99 wt % of the positive electrode active material and 1 wt % to 35 wt %, for example, 80 wt % to 90 wt % of the positive electrode active material and 10 wt % to 20 wt % of the solid electrolyte are included based on the total weight of the positive electrode active material and the solid electrolyte. When the solid electrolyte is included in the positive electrode in such a content, the efficiency and cycle-life characteristics of the all-solid-state battery can be improved without reducing the capacity.

### Binder

The binder serves to well adhere positive electrode active material particles to each other and also to adhere the positive electrode active material to the current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene-butadiene rubber, an acrylated styrene-butadiene rubber, an epoxy resin, nylon, and the like, but are not limited thereto.

The content of the binder in the positive electrode active material layer may be approximately 0.1 wt % to 5 wt % based on 100 wt % of the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The positive electrode current collector may include an aluminum foil, but is not limited thereto.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Manufacturing of Elastic Sheet

70 parts by weight of n-butyl acrylate (BA), 10 parts by weight of 2-hydroxyethyl acrylate (2-HEA), and 20 parts by weight of isobornyl acrylate were mixed as resin components in a reactor to prepare a resin mixture. Subsequently, 0.1 parts by weight of azobisisobutyronitrile as a polymerization initiator and 150 parts by weight of ethyl acetate as a solvent were added to the resin mixture and then, heated to 75° C. to perform a polymerization reaction. In addition, while adding a polymerization catalyst solution, which was prepared by dissolving 0.1 parts by weight of azobisisobutyronitrile in 10 parts by weight of ethyl acetate, the polymerization was completed at the same temperature as above for 8 hours. After completing the polymerization, a dilution solvent (ethyl acetate) was added thereto to prepare a carboxyl-free acrylic copolymer (a solution having a solid content of 35 wt %) with a weight average molecular weight of 1 million.

To the solution of the acrylate copolymer with a weight average molecular weight of 1 million, 7 parts by weight of Exancel 551 DU 40 (Akzo Nobel Chemicals) as a pore-forming agent, 0.2 parts by weight of an isocyanate cross-linking agent (xylylene diisocyanate (XDI), a molecular weight=698 g/mol, trifunctionality, a solid concentration=75 wt %, Takenate D110N made by Mitsui Chemicals, Inc.), and 5 parts by weight of an extinguishing capsule solution with an average particle diameter of 40 μm based on 100 parts by weight of the acrylate copolymer solution were added, and the resulting mixture was coated on a PET release film and then, dried at120° C. for 5 minutes to manufacture an elastic sheet with a thickness of 300 μm. This was used as an elastic sheet including an extinguishing capsule.

On the other hand, separately, an urethane-based elastic sheet not including an extinguishing capsule and having a thickness of about 200 μm was prepared and then, used as an extinguishing capsule not including an elastic sheet.

### 2. Manufacturing of Positive Electrode

85 wt % of LiNi_{0.8}Co_{0.15}Mn_{0.05}O₂ coated with Li₂O—ZrO₂ as a positive electrode active material, 13.5 wt % of Li₃PS₅Cl as a lithium argyrodite-type solid electrolyte, 1.0 wt % of polyvinylidene fluoride as a binder, and 0.5 wt % of carbon nanotube as a conductive material were mixed to prepare a positive electrode composition. The prepared positive electrode composition was coated on a positive electrode current collector with a bar coater and then, dried and compressed, manufacturing a positive electrode.

### 3. Manufacturing of Solid Electrolyte Layer

An acrylic binder (SX-A334, Zeon Corp.) was dissolved in an isobutyryl isobutyrate (IBIB) solvent to prepare a binder solution, and an argyrodite-type solid electrolyte of Li₃PS₅Cl (D50=3 μm) was added thereto and then, stirred to prepare a slurry. The slurry included 98.5 wt % of the solid electrolyte and 1.5 wt % of the binder. The slurry was coated on a PET release film with a bar coater and then, dried at room temperature to form a solid electrolyte layer.

### 4. Manufacturing of Negative Electrode

After preparing an Ag/C composite by mixing carbon black having a primary particle diameter (D50) of about 30 nm with silver (Ag) having an average particle diameter (D50) of about 60 nm in a weight ratio of 3:1, 0.25 g of the Ag/C composite was added to 2 g of an NMP solution including 7 wt % of a polyvinylidene fluoride binder and then, mixed therewith to prepare a negative electrode coating layer composition. The negative electrode coating layer composition was coated on a nickel foil current collector with a bar coater and then, vacuum-dried to prepare a precipitation-type negative electrode having a negative electrode coating layer on the current collector.

5. Manufacturing of all-Solid-State Rechargeable Battery Cell

After stacking the positive electrode, the solid electrolyte layer, and the negative electrode in order to manufacture a unit cell, the elastic sheet was disposed between four unit cells and on the outmost surfaces, wherein, similar to FIG. 2, the elastic sheet including the extinguishing capsule was disposed on the outmost surfaces, but the elastic sheet not including the extinguishing capsule was disposed between the unit cells. This integrated structure was inserted into a laminate film and then, subjected to warm isostatic press (WIP) at 80° C. under 500 Mpa for 30 minutes, manufacturing an all-solid-state rechargeable battery cell.

### Example 2

In order to manufacture an elastic layer, a solvent-free acrylate mixed resin having a weight average molecular weight of 1.2 million was prepared. Herein, the solvent-free acrylate mixed resin with a weight average molecular weight of 1.2 million was prepared by mixing 4-hydroxybutyl acrylate (4-HBA; Osaka Organic Chemical) and 2-EHA (LG Chem) in a weight ratio of 30/70, adding 0.01 parts by weight of a photoinitiator (Irgacure651) thereto, and then, irradiating the mixture with UV.

Based on 100 parts by weight of this solvent-free acrylate mixed resin, 0.5 parts by weight of a photoinitiator (Irgacure 651), 0.3 parts by weight of a cross-linking agent (1,6-hexanediol diacrylate; HDDA; Sigma Aldrich Co., Ltd.), and 6 parts by weight of a pore-forming agent (Expancel 551 DU 40; Akzo Nobel Chemicals), 6 parts by weight of an extinguishing capsule with an average particle diameter of 40 μm were mixed with the solvent-free acrylate mixed resin, and the resulting mixture was coated on a general-purpose PET film and then, irradiated with UV at 2000 mj/cm². The sheet was allowed to stand at 150° C. for 5 minutes to expand the pore-forming agent, manufacturing an elastic sheet with a thickness of 300 μm. The elastic sheet manufactured in this manner was used as an elastic sheet including an extinguishing capsule.

An elastic sheet including an extinguishing capsule was manufactured to have a thickness of 200 μm under the same conditions as above except for using 0.5 parts by weight of a photoinitiator (Irgacure 651), 0.1 parts by weight of a cross-linking agent (1,6-hexanediol diacrylate; HDDA; Sigma Aldrich Co., Ltd.), and 5 parts by weight of a pore-forming agent (Expancel 551 DU 40; Akzo Nobel Chemicals) based on 100 parts by weight of the solvent-free acrylate mixed resin. Except for this, an all-solid-state rechargeable battery cell was manufactured substantially in the same manner as in Example 1.

### Example 3

In order to manufacture an elastic layer, 30 parts by weight of propylene-based polyol with a weight average molecular weight of 4000 was first mixed with 70 parts by weight of polyether-based polyol (viscosity (25° C.): 500 mPas, the number of functional groups: 3, a number average molecular weight: 3000, GP-3000 manufactured by Sanyo Kasei Kogyo Co., Ltd.), and then, a mixture of 11 parts by weight of isocyanate (Lupranate T80, BASF) and 7 parts by weight of extinguishing capsules with an average particle diameter of 40 μm as a cross-linking agent was added to the composition and then, stirred by injecting nitrogen at 100 cc/min for 5 minutes, coated on a PET film, and heated at 100° C. to 150° C. to manufacture an elastic sheet with a thickness of 300 μm. This elastic sheet was used as an elastic sheet including an extinguishing capsule.

An elastic sheet not including an extinguishing capsule was manufactured to have a thickness of 200 μm in the same manner as above except that 40 parts by weight of propylene-based polyol with a weight average molecular weight of 4000, 60 parts by weight of polyether-based polyol (viscosity (25° C.): 500 mPa·s, the number of functional groups: 3, a number average molecular weight: 3000, GP-3000 manufactured by Sanyo Kasei Kogyo Co., Ltd.) were mixed, and then, 19 parts by weight of isocyanate (Lupranate T80, BASF) as a cross-linking agent was added to the composition

### Comparative Example 1

An all-solid-state rechargeable battery cell was manufactured substantially in the same manner as in Example 1 except that the elastic sheet not including the extinguishing capsule was all applied between unit cells and on the outmost surfaces.

### Comparative Example 2

An all-solid-state rechargeable battery cell was manufactured substantially in the same manner as in Example 2 except that the elastic sheet not including the extinguishing capsule was all applied between unit cells and on the outmost surfaces.

### Comparative Example 3

An all-solid-state rechargeable battery cell was manufactured substantially in the same manner as in Example 3 except that the elastic sheet not including the extinguishing capsule was all applied between unit cells and on the outmost surfaces.

### Evaluation Example 1: Evaluation of Physical Properties of Elastic Sheet

Each of the elastic sheets including extinguishing capsule and the elastic sheets not including extinguishing capsule according to Examples 1 to 3 were evaluated with respect to physical properties, and the results are shown in Table 1.

TABLE 1

| | Example1 | | Example2 | | Example3 | |
|---|---|---|---|---|---|---|
| Presence or | ◯ | X | ◯ | X | ◯ | X |
| absence of | | | | | | |
| extinguishing | | | | | | |
| capsule | | | | | | |
| Modulus 25° C., | 1.92 × 10⁶ | 1.22 × 10⁶ | 6.69 × 10⁵ | 5.91 × 10⁵ | 7.45 × 10⁵ | 7.25 × 10⁵ |
| 1 Hz, Pa | | | | | | |
| Permanent strain | 48 | 47 | 45 | 38 | 40 | 38 |
| (%) | | | | | | |
| impact absorption | 51 | 55 | 50 | 51 | 50 | 51 |
| rate (%) | | | | | | |
| CFD 50% | 1.8 | 1.6 | 1.7 | 1.6 | 1.6 | 1.5 |
| compressive | | | | | | |
| strength (MPa) | | | | | | |
| Stress relaxation | 13 | 17 | 10 | 11 | 10 | 12 |
| rate (%) | | | | | | |
| Recovery rate (%) | 73 | 71 | 76 | 75 | 74 | 73 |

The modulus was measured by using an Anton Paar rheometer (MCR-302), while increasing a temperature at 5° C./min within a range of −20° C. to 80° C. at a frequency of 1 Hz. The permanent strain was obtained according to Calculation Equation 1 by placing a 1.5 mm-thick SUS plate on a 10 mm or more thick stainless steel plate, stacking each elastic sheet to be 3 mm thick, turning screws on the side to press it with the 10 mm or more thick stainless steel plate until it became 1.5 mm thick, storing it at 50° C. for 7 days, and dismantle it to measure its thickness.

$$Permanent strain ( \% ) = \{ \vert ( thickness of specimen recovered after compression ) - ( 3 mm ) \vert / ( 3 mm ) \} \times 100 \qquad [ Calculation Equation 1 ]$$

The impact absorption rate was calculated according to Calculation Equation 2 by dropping 7 g of a weight from a vertical height of 20 cm at 25° C. on each elastic sheet specimen to measure an impact force (N) generated from the ball drop in a ball drop method.

$$Impact absorption rate ( \% ) = \{ [ ( impact force measured without elastic sheet ) - ( impact force with elastic sheet ) ] / ( impact force measured without elastic sheet ) \} \times 100 \qquad [ Calculation Equation 2 ]$$

The compressive strength may be 50% CFD (Compression Force Deflection) at a point where each elastic layer was physically pressed to 50% at 25° C., that is, a point where its thickness became 50% of the initial thickness and calculated according to Calculation Equation 3. In addition, CFD 70% compressive strength was calculated according to Calculation Equation 3 by using a compression tester having a spherical shape jig with a diameter of 10 mm to apply a pressure to each specimen at a compression ratio of 0.6 mm/min (10 μm/sec) at 25° C. and thus obtain a load at a point where the specimen reached 30% of its initial thickness after the pressurization, and the result are shown in Table 1.

$$Compressive strength ( MPa ) = \{ [ Load at 50 \% compression ( kgf ) ] / [ Area of test piece ( {cm}^{2} ) ] \} \times 0.1 \qquad [ Calculation Equation 3 ]$$

The stress relaxation rate was calculated according to Calculation Equation 4 by obtaining a stress change for 60 seconds after compressing each elastic layer to 40 μm under a pressure condition of 2.5 kgf. The recovery rate was a change in stress at a point where each elastic layer was completely relaxed after compressing each elastic layer to 40 μm (after 60 seconds) and calculated according to Calculation Equation 5.

$$Stress relaxation rate ( \% ) = ( Stress after 60 seconds of 40 μm compression ) / ( Initial stress at 40 μm compression ) \times 100 \qquad [ Calculation Equation 4 ]$$

$$Recovery rate ( \% ) = ( Stress when restored to the original point 60 seconds after 40 μm compression ) / ( Initial stress when 40 μm compressed ) \times 100 \qquad [ Calculation Equation 5 ]$$

### Evaluation Example 2: Safety Evaluation of all-Solid-State Rechargeable Battery Cell

The all-solid-state rechargeable battery cells according to Examples 1 to 3 and Comparative Examples 1 to 3 were placed on a hot plate at 180° C. to evaluate whether or not combusted and combustion time, and the results are shown in Table 2.

TABLE 2

| | | | | Comparative | Comparative | Comparative |
|---|---|---|---|---|---|---|
| | Example 1 | Example 2 | Example 3 | Example 1 | Example 2 | Example 3 |
| Combustion | <10 s | <9 s | <8 s | all | all | all |
| time | | | | combusted | combusted | combusted |

Referring to Table 2, the all-solid-state rechargeable battery cells of Comparative Examples 1 to 3 were all combusted at high temperatures, whereas the all-solid-state rechargeable battery cells of Examples 1 to 3 had combustion times of less than 10 seconds, which indicates ensuring of safety.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

<Description of Symbols>

| | |
|---|---|
| 100: all-solid-state battery | 200: positive electrode |
| 201: positive electrode current collector | |
| 203: positive electrode active material layer | |
| 300: solid electrolyte layer | 400: negative electrode |
| 401: negative electrode current collector | |
| 403: negative electrode active material layer | |
| 400′: precipitation-type negative electrode | 404: lithium metal layer |
| 405: negative electrode coating layer | 500: elastic layer |

1. An all-solid-state rechargeable battery structure, comprising
two or more unit cells including a positive electrode, a negative electrode, and a solid electrolyte layer between the positive electrode and the negative electrode, and
elastic sheets between the unit cells and at the outermost end of the unit cells,
wherein at least one of the elastic sheets include an extinguishing capsule.

2. The all-solid-state rechargeable battery structure as claimed in claim 1, wherein
an average particle size of the extinguishing capsule is 100 nm to 50 μm.

3. The all-solid-state rechargeable battery structure as claimed in claim 1, wherein
the extinguishing capsule is included in an amount of 1 wt % to 40 wt % based on 100 wt % of one elastic sheet.

4. The all-solid-state rechargeable battery structure as claimed in claim 1, wherein
the extinguishing capsule has a core-shell structure,
the core includes an extinguishing agent, and
the shell includes a polymer that melts at 80° C. to 160° C.

5. The all-solid-state rechargeable battery structure as claimed in claim 4, wherein
in the core, the extinguishing agent includes iodotrifluoromethane, 1-iodoheptafluoropropane, 2-iodoheptafluoropropane, iodopentafluoroethane, 2,2-diiodo-1,1,1,3,3,3-hexafluoropropane, 1,2-dibromoethane, dibromomethane, or a combination thereof.

6. The all-solid-state rechargeable battery structure as claimed in claim 4, wherein
in the shell, the polymer that melts at 80° C. to 160° C. includes polystyrene, polyurethane, polyurea, polyepoxide, polynitrile, polyacrylate, polyamide, a copolymer thereof, or a mixture thereof.

7. The all-solid-state rechargeable battery structure as claimed in claim 1, wherein
a thickness of the elastic sheet is 100 μm to 800 μm.

8. The all-solid-state rechargeable battery structure as claimed in claim 1, wherein
the elastic sheet includes a polymer resin, and the polymer resin includes polyacrylate, polyurethane, silicone, a fluorine-based polymer, a copolymer thereof, or a combination thereof.

9. The all-solid-state rechargeable battery structure as claimed in claim 1, wherein
the all-solid-state rechargeable battery structure includes both an elastic sheet including an extinguishing capsule and an elastic sheet not including an extinguishing capsule.

10. The all-solid-state rechargeable battery structure as claimed in claim 1, wherein
the elastic sheet located between the unit cells do not include an extinguishing capsule, and the elastic sheet located at the outermost end of the unit cells include an extinguishing capsule.

11. The all-solid-state rechargeable battery structure as claimed in claim 10, wherein
a density of the elastic sheet located between the unit cells and not including an extinguishing capsule is 0.3 g/cm³ to 1.0 g/cm³, and
a density of the elastic sheet located at the outermost end of the unit cells and including the extinguishing capsule is 0.7 g/cm³ to 6 g/cm³.

12. The all-solid-state rechargeable battery structure as claimed in claim 10, wherein
a thickness of the elastic sheet located between the unit cells and not including an extinguishing capsule is 100 μm to 300 μm, and
a thickness of the elastic sheet located at the outermost end of the unit cells and including the extinguishing capsule is 150 μm to 800 μm.

13. The all-solid-state rechargeable battery structure as claimed in claim 10, wherein
a modulus of the elastic sheet located between the unit cells and not including an extinguishing capsule is 1×10⁵ Pa to 6×10⁶ Pa at 25° C. and a frequency of 1 Hz, and
a modulus of the elastic sheet located at the outermost end of the unit cells and including the extinguishing capsule is 1×10⁵ Pa to 6×10⁶ Pa at 25° C. and a frequency of 1 Hz.

14. The all-solid-state rechargeable battery structure as claimed in claim 13, wherein
the modulus of the elastic sheet located at the outermost end of the unit cells and including the extinguishing capsule is higher than the modulus of the elastic sheet located between the unit cells and not including the extinguishing capsule.

15. The all-solid-state rechargeable battery structure as claimed in claim 10, wherein
a permanent strain of the elastic sheet located at the outermost end of the unit cells and including the extinguishing capsule is higher than a permanent strain of the elastic sheet located between the unit cells and not including the extinguishing capsule.
